(19) United States
(12) Patent Application Publication
(10) Pub. No.: US 2018/0244342 A1
(43) Pub. Date: Aug. 30, 2018

(54) TRANSMISSION SYSTEMS AND IMPROVEMENTS RELATING TO BICYCLES AND VEHICLES

(71) Applicant: FREEFLOW TECHNOLOGIES LIMITED, Glasgow (GB)

(72) Inventor: Neil MACMARTIN, Glasgow (GB)

(21) Appl. No.: 15/755,518

(22) PCT Filed: Aug. 24, 2016
(86) PCT No.: PCT/GB2016/052625

§ 371 Date: Feb. 26, 2018

(30) Foreign Application Priority Data
Aug. 25, 2015 (GB) 1515082.4

(51) Int. Cl. B62M 6/55

(52) U.S. Cl. CPC B62M 6/55; B62M 2701/0092; B62M 2701/0015

(57) ABSTRACT

A transmission system is described comprising a first rotational input, a second rotational input and a rotational output, wherein the first rotational input and second rotational input may transmit a rotation to the rotational output, wherein one of the first rotational input and second rotational input is connected to the rotational output through a one way clutch, and wherein the other of the first rotational input and second rotational input is connected to the rotational output through an overrunning clutch, wherein said one way clutch and said overrunning clutch are rotationally coupled are described in the present disclosure. Further, there is described bicycles and vehicles including such a transmission system. Also described is a control system which may be used in electrical vehicles, including electric bicycles, having such a transmission system. Further, there is detail relating to novel bicycle frames and method of constructing such bicycle frames to house such transmission systems and control systems.

### FIELD OF THE INVENTION

The present disclosure covers a vehicle, especially an electrically assisted or powered bicycle, a transmission system usable therewith but also applicable to other applications, a control system for said vehicle, and a method of frame construction for bicycles.

### BACKGROUND TO THE INVENTION

Electric bicycles are a form of dual-powered vehicles: they employ both a manual pedal and crank drive and an electric motor. These two drives may function independently of one another or may function together to augment one another's motive force. A user may choose to selectively engage the electric drive, or the electric drive may be activated automatically depending on such conditions as the measured pedal velocity, bicycle velocity, etc.

The electric drive may be located in several places; it may drive and be located within the hub of the rear wheel; it can power the pedal crank; or it may be located at some point between these two extremes, driving the chain of the bicycle. An alternative is to drive the front wheel, but this brings its own drawbacks.

The power source, usually a rechargeable battery, has to be located on the bicycle, and usually a bulky battery will be placed over or around the rear wheel.

Laws are in place around the world to limit the speed at which the electrical drive may propel such a bicycle, primarily for the safety of the user. The speed may be limited to around 15 mph. However, the user may be free to manually propel the bicycle beyond this velocity.

Drawbacks of current electrical bicycles include the bulk of the drive/battery mechanism making the bicycle cumbersome for the rider.

A further drawback is in the potential for crank-driven pedalling or sudden cessation to damage the motor if that drives the crank. For example, an electric bicycle may be travelling under combined electric drive and user pedalling. If the user has to undertake an emergency stop, their reaction is to immediately stop pedalling holding the crank at a fixed angle.

Whilst the bicycle may be provided with a brake lever mounted electric drive cut-off, the cessation of pedalling by the user may occur before this is activated and there will be a short period of time where the electric motor is driving the crank while the user is attempting to simultaneously hold the crank static. This can lead to the motor being damaged and/or the user's feet being forced around in an unwanted, unsettling and perhaps unbalancing pedalling motion.

A further drawback of electric vehicles, and especially electric bicycles, is that the rider and cargo's mass has relatively little effect upon power consumption when the bicycle is on a level gradient, but has a greater effect when travelling uphill. Prior art electric bicycles will not generally take this mass differential into account and simply provide a maximum power to the electrical motor to aid the user. This leads to unnecessary power usage if the rider and cargo or of an average or below average mass.

It has been proposed to mount a power source and propulsion system within a down-tube of a bicycle frame, and have a transmission system which is partially or wholly located within the bottom bracket shell and transmits additional power to the bottom bracket and crank-set at this point.

Whilst advantageous in some respects, there may be difficulty in repairing or servicing the transmission system, power source and/or propulsion system with this arrangement.

### SUMMARY OF THE INVENTION

According to a first aspect of the present invention there is provided a transmission system comprising a first rotational input, a second rotational input and a rotational output, wherein the first rotational input and second rotational input may transmit a rotation to the rotational output, wherein one of the first rotational input and second rotational input is connected to the rotational output through a one way clutch, and wherein the other of the first rotational input and second rotational input is connected to the rotational output through an overrunning clutch, wherein said one way clutch and said overrunning clutch are rotationally coupled.

The one way clutch may be rotationally coupled to the overrunning clutch by a bracket.

The bracket may comprise a cylindrical housing and a cylindrical mounting.

The bracket may comprise a mounting axle with a cylindrical housing rotationally coupled and locked to the mounting axle and the cylindrical housing may extend around at least a portion of the mounting axle.

The axis of rotation of the first rotational input may be perpendicular to the axis of rotation of the second rotational input.

The axis of rotation of the rotational output may be parallel to either the axis of rotation of the first rotational input or the second rotational input.

One of the one way clutch and overrunning clutch may be mounted within the cylindrical housing and the other of the one way clutch and overrunning clutch may be mounted around the cylindrical mounting.

The one way clutch may be mounted within the cylindrical housing with an outer race of said one-way clutch rotationally coupled to an inner surface of the cylindrical housing and the overrunning clutch may be mounted around the cylindrical mounting.

The one way clutch may be a sprag clutch.

The first or second rotational input may be an electric motor.

The other of first or second rotational input may be manually driven.

The mounting axle may be rotationally coupled to a second axle.

The second axle may surround the mounting axle.

The inner race of said one-way clutch may be rotationally coupled to an outer surface of second axle and the overrunning clutch may be mounted around the outer surface of the second axle.

The overrunning clutch may be rotationally coupled to a bevel gear.

The overrunning clutch may be rotationally coupled to a hypoid gear.

The transmission system may be mounted within a housing.

The housing may be formed from a plastics material, such as SLS or glass filled nylon.

The housing may be adapted to be connectible to a bicycle frame.

The housing may be adapted to be connectible into the usual position of the bottom bracket shell of a bicycle frame, namely adjacent the junction between the down tube, seat tube and chain stay on the bicycle frame.

The housing may further include one or more motors, and these may be electrical motors.

The housing may further include one or more components of a crank-set.

The housing may include a main housing within which are located the majority or all of the components of the transmission system and a cover enabling access to the transmission system.

According to a second aspect of the present invention there is provided a bicycle including a transmission system according to the first aspect.

According to a third aspect of the present invention there is provided a vehicle including a transmission system according to the first aspect.

The transmission system of the first aspect of the present invention may be usable within other rotational motion applications; such as wind turbines, ships, boats, aircraft, machines, tools, etc.

According to a fourth aspect of the present invention there is provided a control system for a vehicle comprising at least three sensory inputs combining to provide a control signal output.

There may be four sensory inputs.

One of the sensory inputs may be a torque sensor measuring a first rotational input torque.

One of the sensory inputs may be a weight sensor measuring the load on the vehicle including the passenger(s) weight.

One of the sensory inputs may be a Boolean wheel rotation sensor measuring whether a wheel of said vehicle is rotating.

One of the sensory inputs may be a wheel velocity sensor measuring the rotational speed of a wheel.

Both wheel sensors may be measuring one wheel of a vehicle or they may measure separate wheels.

Further sensory inputs are possible.

According to a fifth aspect of the present invention there is provided an electric bicycle including at least one control system according to the fourth aspect of the present invention.

According to a sixth aspect of the present invention there is provided a vehicle including at least one control system according to the fourth aspect of the present invention.

According to a seventh aspect of the present invention there is provided a bicycle frame including a down-tube, seat-tube and chain-stay, wherein the down-tube, seat-tube and chain-stay are connected, the down-tube being hollow and including a chamber therein, the down-tube having an aperture adjacent a connection point of the seat-tube and/or chain-stay.

The aperture may be located distally from the connection point of the of the seat-tube and/or chain-stay.

With the frame in an upright orientation, the aperture may be located at the bottom-most portion of the frame.

The down-tube may be of a sufficient size to receive internal components, such as a battery pack.

The aperture may be adapted to receive one or more components.

The aperture may be adapted to receive a crank-set.

The aperture may be adapted to receive a powered propulsion system, such as an electrical motor.

The aperture may be adapted to receive both a crank-set and a powered propulsion system.

The aperture may be adapted to receive a housing unit including a crank-set and/or a powered propulsion system.

The aperture may be adapted to receive a housing with a transmission system according to the first aspect of the present invention.

The down-tube may include a bracing structure located adjacent the aperture.

The bracing structure may comprise a localised thickening of the down-tube wall thickness.

The bracing structure may comprise a separate plate welded to the down-tube.

According to an seventh aspect of the present invention there is provided a bicycle including a frame according to the sixth aspect.

According to an eighth aspect of the present invention there is provided a method of manufacture of a bicycle frame, comprising the steps of:
cutting an aperture from a lower portion of a down-tube on the lower surface of said down-tube;
joining the chain-stays to the lower portion of the down-tube on the upper surface of said down-tube adjacent said aperture;
joining the seat-tube to the lower portion of the down-tube on the upper surface of said down-tube adjacent said aperture and up-tube of the chain-stays.

The method may include attaching a strengthening brace over the upper surface adjacent the aperture.

The chain-stays and/or seat-tube may attach to the strengthening brace.

A power source, propulsion system and/or a transmission system may be joined to and/or within the down-tube, via said aperture.

The power source, propulsion system and/or a transmission system may be housed within a housing or chassis.

The housing or chassis may house a transmission system and propulsion system.

A power source may be locatable within the hollow down-tube.

### BRIEF DESCRIPTION OF THE DRAWINGS

Embodiments of the various aspects of the present invention will now be described, by way of example only, with reference to the following drawings in which:

FIG. 1 is a side elevation of a bicycle including the various aspects of the present invention;

FIG. 2 is a side elevation of the frame of the bicycle of FIG. 1 and according to the seventh aspect of the present invention;

FIG. 3 is a plan view of the frame of FIG. 2;

FIG. 4 is a detail view of the down-tube aperture of the frame of FIG. 2;

FIG. 5 is a perspective view of the join of the down-tube, chain-stays and seat-tube of the frame of FIG. 2;

FIG. 6 is a perspective view of the lower aperture and internal chamber of the frame of FIG. 2;

FIG. 7 is a perspective view from below of a propulsion and transmission system of the bicycle of FIG. 1;

FIG. 8 is a perspective view of a propulsion and transmission system of the bicycle of FIG. 1;

FIG. 9 is an exploded perspective view a propulsion and transmission system of the bicycle of FIG. 1;

FIG. 10 is a perspective view of a propulsion and transmission system of the bicycle of FIG. 1;

FIG. 11 is a plan view of a gear axle of the propulsion and transmission system of the bicycle of FIG. 1;

FIG. 12 is a perspective view from a first side of the central axle of the propulsion and transmission system of the bicycle of FIG. 1;

FIG. 13 is a perspective view from a second side of the central axle of the propulsion and transmission system of the bicycle of FIG. 1;

FIG. 14 is a perspective view from a first side of a splined stud of the propulsion and transmission system of the bicycle of FIG. 1;

FIG. 15 is a perspective view from a second side of a splined stud of the propulsion and transmission system of the bicycle of FIG. 1;

FIG. 16 is a perspective view from a first side of a crank-set spider of the propulsion and transmission system of the bicycle of FIG. 1;

FIG. 17 is a perspective view from a second side of a crank-set spider of the propulsion and transmission system of the bicycle of FIG. 1;

FIG. 18 is a perspective view from a first side of a second axle of the propulsion and transmission system of the bicycle of FIG. 1;

FIG. 19 is a perspective view from a second side of a second axle of the propulsion and transmission system of the bicycle of FIG. 1;

FIG. 20 is a sectional elevation of the second axle of FIGS. 18 & 19;

FIG. 21 is a plan view of the second axle of FIGS. 18 & 19;

FIG. 22a is a perspective view from below of a phosphorous bronze hypoid gear mounted on a one-way over-running bearing of the propulsion and transmission system of the bicycle of FIG. 1;

FIG. 22b is a perspective view of a phosphorous bronze hypoid gear mounted within a thrust bearing on beside a one-way over-running bearing of the propulsion and transmission system of the bicycle of FIG. 1;

FIG. 22c is a perspective view of a phosphorous bronze hypoid gear mounted within a thrust bearing on a one-way over-running bearing of the propulsion and transmission system of the bicycle of FIG. 1;

FIG. 23 is an end elevation of a wheel-shaped bearing mount of the propulsion and transmission system of the bicycle of FIG. 1;

FIG. 24 is a side elevation of a wheel-shaped bearing mount of the propulsion and transmission system of the bicycle of FIG. 1;

FIG. 25 is a perspective view from a first side of a wheel-shaped bearing mount of the propulsion and transmission system of the bicycle of FIG. 1;

FIG. 26 is a perspective view from a second side of a wheel-shaped bearing mount of the propulsion and transmission system of the bicycle of FIG. 1;

FIG. 27 is an end elevation of a one way bearing of the propulsion and transmission system of the bicycle of FIG. 1;

FIG. 28 a perspective view of a one way bearing of the propulsion and transmission system of the bicycle of FIG. 1;

FIG. 29 is a perspective view of the central axle, brass bush and small inner crank-side bearing assembly of the propulsion and transmission system of the bicycle of FIG. 1;

FIG. 30 is a perspective view of the central axle and second axle assembly of the propulsion and transmission system of the bicycle of FIG. 1;

FIG. 31 is a perspective view of the central axle, second axle and right hand crank arm assembly of the propulsion and transmission system of the bicycle of FIG. 1;

FIG. 32 is a perspective view of the central axle, second axle, right hand crank arm and crank spider assembly of the propulsion and transmission system of the bicycle of FIG. 1;

FIG. 33 is a perspective view of the transmission system of the bicycle of FIG. 1 from the crank side;

FIG. 34 is a perspective view of the transmission system of the bicycle of FIG. 1 from the opposite crank side; and

FIG. 35 is a perspective view of the interior arrangement of the power source of the bicycle of FIG. 1.

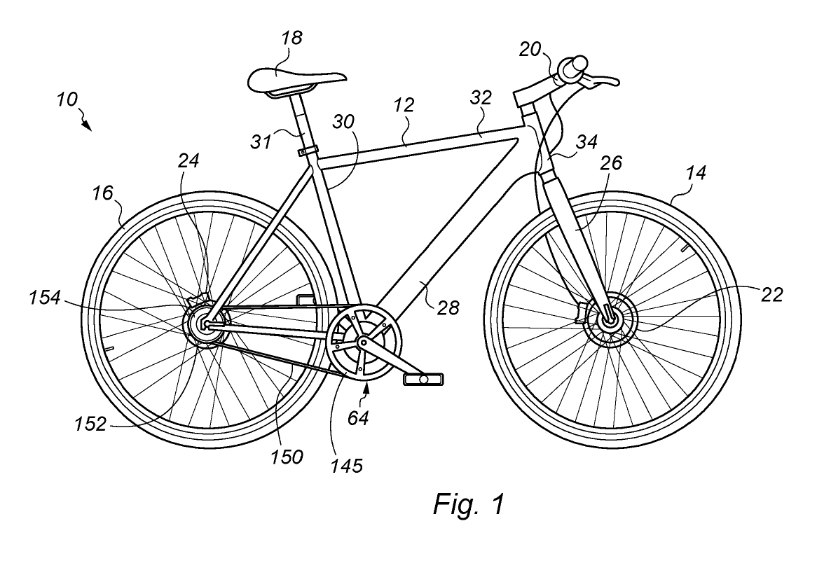

Referring to the drawings and initially to FIG. 1, a bicycle 10 is depicted. The bicycle or bike 10 comprises a frame 12, front wheel 14, rear wheel 16, seat 18, handlebars 20, front disc brake assembly 22, a rear disc brake assembly 24 and front forks 26.

Frame 12 comprises down-tube 28, seat-tube 30, top-tube 32, head-tube 34, chain-stays 36 and seat stays 38. The chain-stays 36 and seat-stays 38 join at a rear-wheel brackets 39.

The frame 12 is a standard diamond style of frame; however, it will be appreciated by the skilled addressee that this may be modified and may be, for example, a step-through style, a cantilever style, a truss style, Y-foil, etc. The frame 12 is composed of aluminium alloy commonly used in such frames, typically either a 6061 or 7005 alloy, which has been TIG welded. The frame 12 is substantially similar in construction to most prior art frames, differing in a few key details.

Most prior art frames tend to have fairly uniform and common tube diameter between down-tube, seat-tube, top-tube and head-tube. Moreover, a bottom bracket shell will be located at the junction of the down-tube, seat-tube and chain-stays. A bottom bracket shell is a short hollow tube orientated parallel to the axis of rotation of the rear wheel, and within it mounts the bottom bracket upon which are mounted the crank arms enabling the bicycle to be pedalled.

In the present embodiment, the down-tube 28 is of an appreciably larger diameter (circa 79 mm internal diameter, 82 mm external diameter) than many prior art frames, and furthermore, there is no bottom bracket shell.

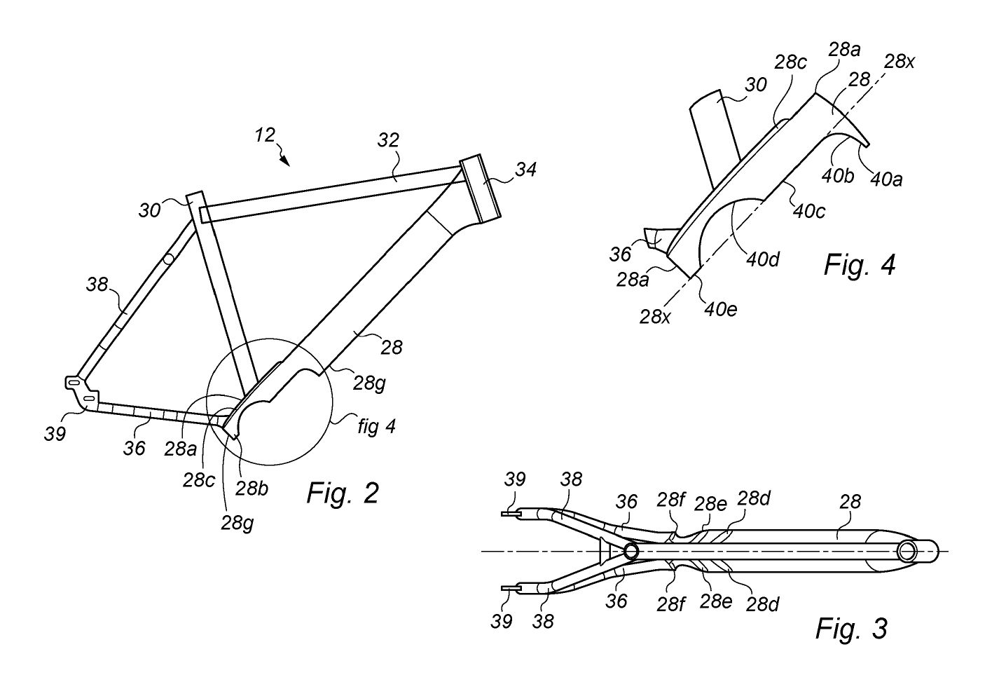

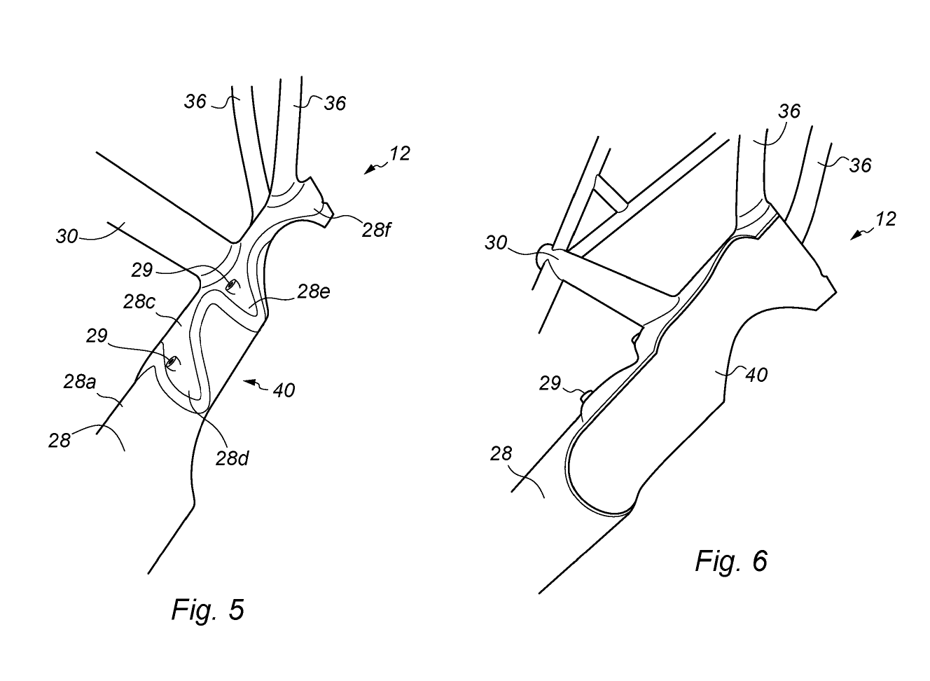

As can be seen from FIGS. 2 to 6, seat-tube 30 and chain-stays 36 all attach to an upper surface 28a of a lower portion 28b of the down-tube 28. A strengthening brace 28c has been welded onto the upper surface 28a and the seat-tube 30 and chain-stays 36 have been in turn welded to the strengthening brace 28c. Although welding is used in the present embodiment, it will be understood by the skilled addressee that other joining methods may be used, such as brazed tubing and so forth.

The strengthening brace 28c is a six-lobed “claw” or “spider” shaped piece of material, the same material used for the construction of the rest of the frame 12. The strengthening brace is approximately 240 mm long. This is TIG welded to the upper surface 28a, with front lobes 28d being located forward (i.e. towards head tube 34) of the seat-tube 30 join; centre lobes 28e being located adjacent the seat-tube 30 join and rear lobes 28f being located adjacent the chain-stays 36 join (i.e. towards the rearmost portion of the down-tube 28).

Tapped bore-holes 29 are provided on each of the lobes 28d, 28e, 28f.

An aperture 40 is located on the opposite side of the down-tube 28 from the strengthening brace 28c i.e. on lower surface 28g. The aperture 40 is cut out of the down-tube 28, but may be formed by other processes.

The aperture 40 covers roughly 50% of the circumference of the lower portion 28b of the down-tube 28 and encompasses much of the lower portion 28b of the down-tube 28. The aperture 40 in the present invention is simply cut from the down-tube 28, but may be moulded into the down-tube 28 without departing from the scope of the present invention.

The aperture 40 commences at its uppermost point 40a with a cut perpendicular to the central axis 28x of the down-tube 28. The initial portion 40b is curved around until the aperture 40 boundary is parallel to the central axis 28x. This second portion 40c of the aperture runs for approximately 40% of the aperture 40 length, or roughly 100 mm (the aperture itself being about 230 mm in length).

A second curved section 40d is cut further into the material of the down-tube 28, adjacent the seat-tube 30 join. The semi-circular cut has a radius of 54.3 mm and leads to the end portion 40e of the aperture 40. This end portion 40e runs coaxial with the second portion 40c. The lower end 28g of the down-tube 28 is open. A chamber 38 is defined in the interior of the down-tube 28, accessible via the aperture 40.

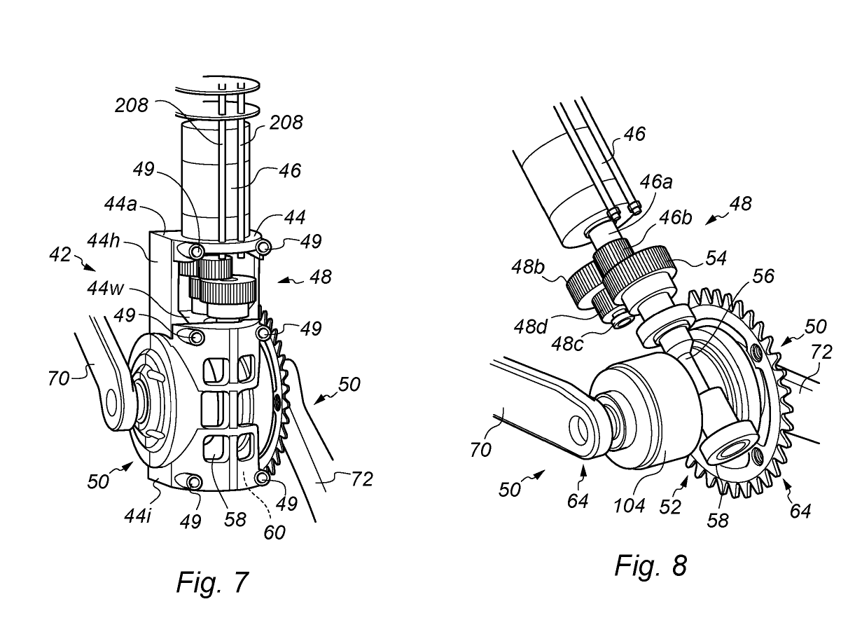

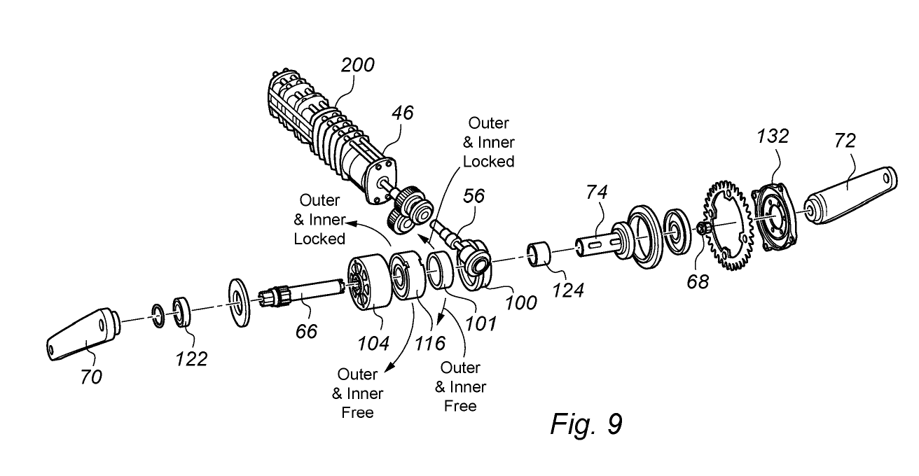

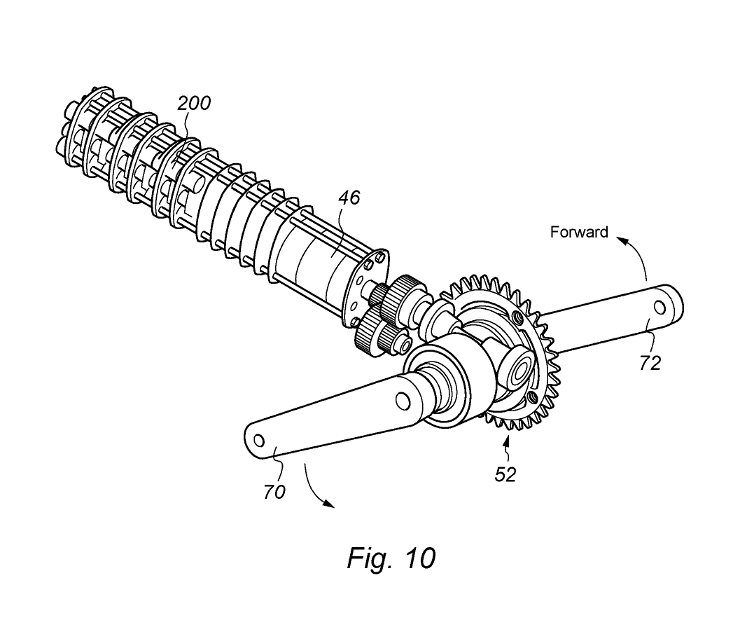

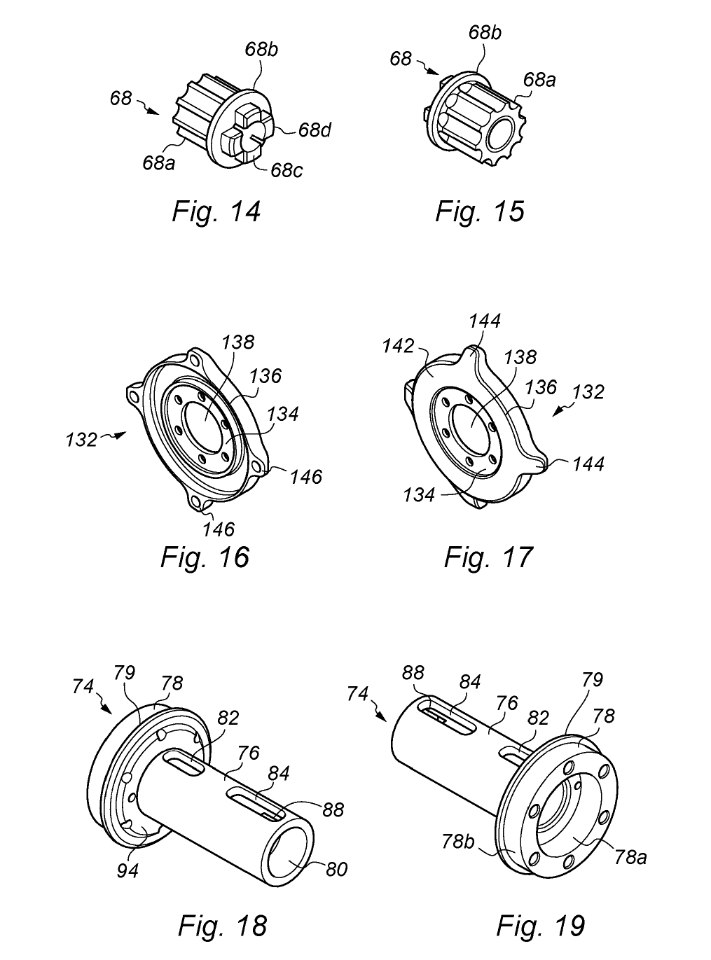

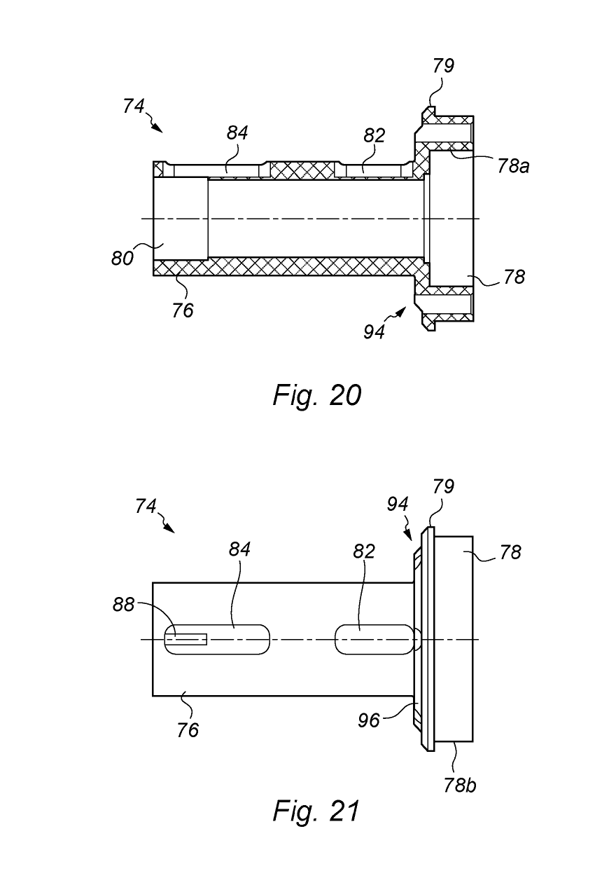

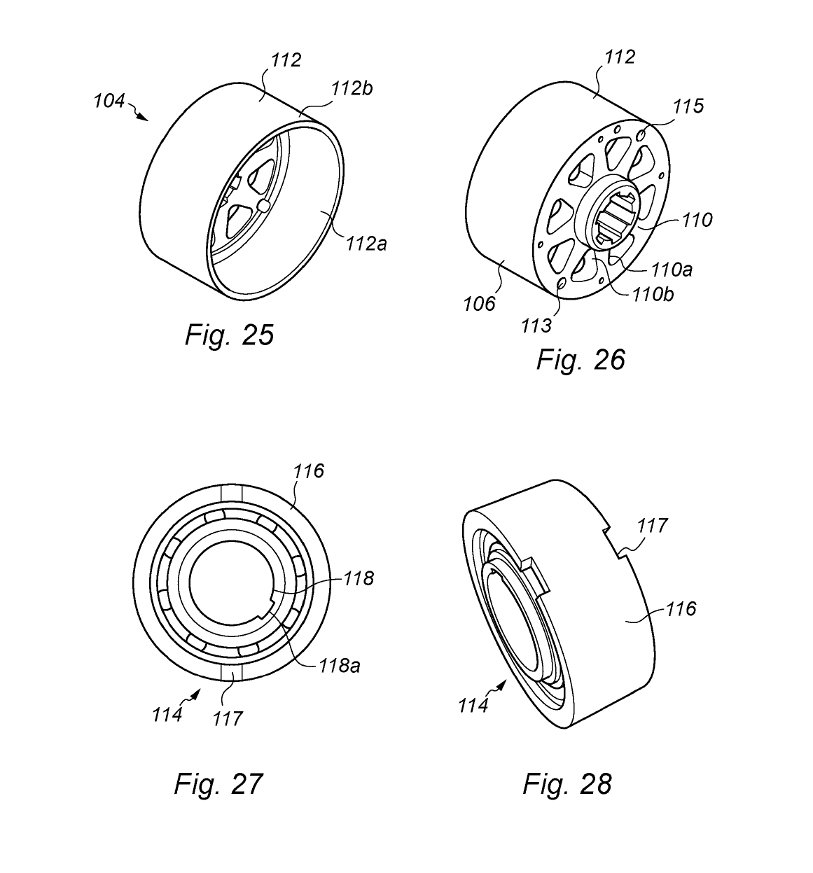

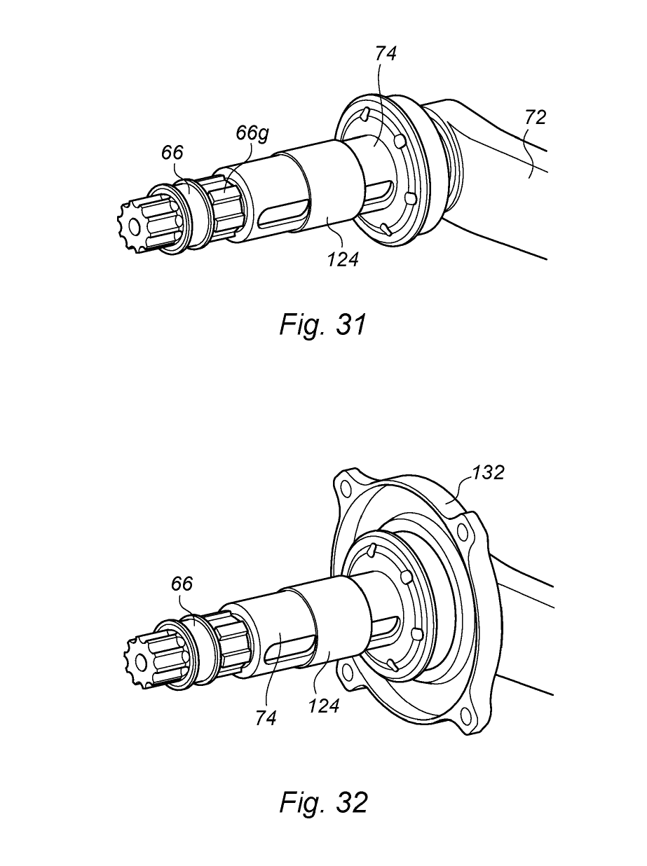

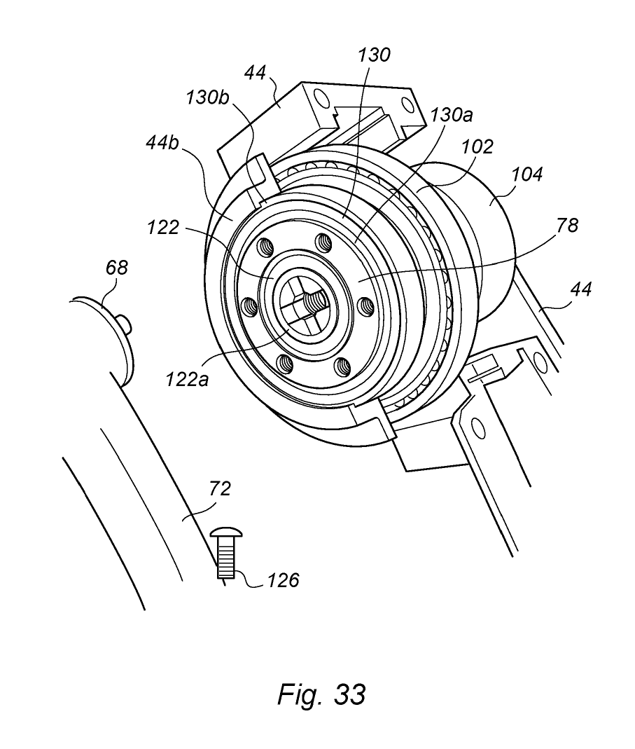

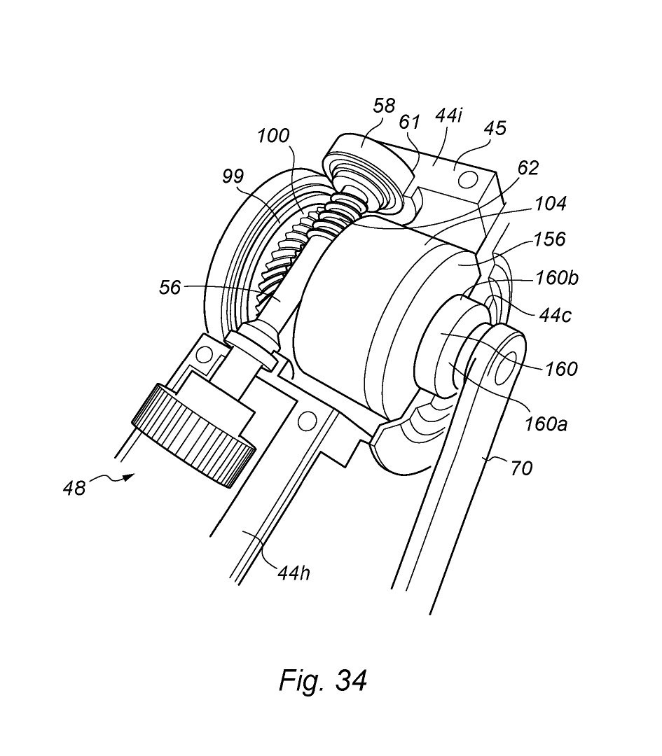

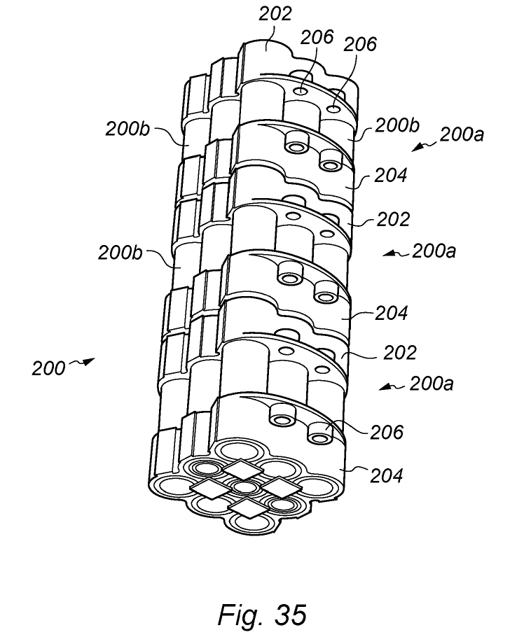

A propulsion unit 42 and its components are depicted in FIGS. 7 to 35.

Propulsion unit 42 comprises a chassis or housing 44, an electric motor 46 attached to a first end 44a of the chassis or housing 44, a step-down gearing unit 48, a manual mechanical propulsion unit 50, and a dual input transmission unit 52.

The chassis or housing 44 is formed from a Nylon SLS, but may also be formed from other suitable materials, such as a glass filled nylon. It may also be formed from a suitable non-plastics material, but plastics material provides several advantages, such as lack of corrosion from environmental factors.

The chassis or housing 44 is formed in two parts: main chassis body 45 and chassis cover 47. The majority of the components subsequently described are housed mainly within the main chassis body 45.

The chassis or housing 44 attaches to frame 12 via aperture 40. Bolts (not shown) attach the chassis or housing 44 to the frame. Six chassis mounting apertures 49 are provided on chassis or housing 44 for this purpose. Bolts (not shown) are located within chassis mounting apertures 49 and attaching to the tapped bore-holes 29 provided on each of the lobes 28d, 28e, 28f. Nuts (not shown) and washers (now shown) may be used in addition to the bolts and threading of the tapped bore-holes 29.

Battery 200 is located within chamber 38 of frame 12. Electric motor 46 is positioned within the chamber 38 located adjacent the battery 200 and proximal to aperture 40.

This arrangement enables the chassis or housing 44 to be easily removed from frame 12 to allow maintenance or repair on the constituent part of the propulsion unit 42.

The electric motor 46 is a high velocity unit, rated to speed in excess of 10,000 RPM. It has a nominal power rating of 300 W, but may have an intermittent demand of 700 W. Since the electric motor 46 is a high speed unit, it may be relatively small to fit within the confines of the frame 12 and especially down-tube 28.

An electric motor pinion 46b attaches to the spindle 46a of the electric motor 46. The pinion 46b is a simple spur-type, and is formed from a metal, specifically a hardened steel.

Pinion 46b drives first step down (i.e. speed reduction) cogwheel 48b, which is also a simple spur-type, and is formed from polyoxymethylene (DELRIN®). Use of a plastics material in conjunction with the hardened steel mitigates the requirement for lubrication of the system and can be run “dry” i.e. no requirement for full or partial immersing in lubrication.

Cogwheel 48b is mounted on a spindle 48c, and a second hardened steel pinion 48d attaches around spindle 48c and is rotationally coupled with cogwheel 48b.

Second hardened steel pinion 48d drives second plastic cogwheel 54. Second plastic cogwheel 54 is also formed from polyoxymethylene (such as DELRIN® plastics).

The overall step down ratio produces a reduction in rotational speed and proportional increase in torque is achieved.

The above described arrangement of cogwheels 48b, 54 pinion 48d and spindle 48c comprise the step-down gearing unit 48.

A gearbox housing 44h houses the step-down gearing unit 48; the gearbox housing 44h being part of the housing or chassis 44, integrally formed therein, but separate from the transmission unit housing 44i by virtue of an interior wall 44w

Second plastic cogwheel 54 is mounted on and rotationally coupled to gear axle 56. A plastic boss 55 extends from the second plastic cogwheel 54 Thrust bearing 58 supports the gear axle 56 at its distal end and is housed within a thrust bearing mounting 60 formed in the housing or chassis 44. Thrust bearing 58 is a spherical roller thrust bearing.

A metal boss 59 is disposed around the gear axle 56, adjacent the plastic boss 55, and distally from the second plastic cogwheel 54. The metal boss 59 locates within a boss mounting 61 formed on the housing or chassis 44, specifically in interior wall 44w. A metal boss flange 63 is located at the end of the metal boss 59; the end located distally from the plastic boss 55.

A worm gear 62 is disposed on the gear axle 56 adjacent the thrust bearing 58.

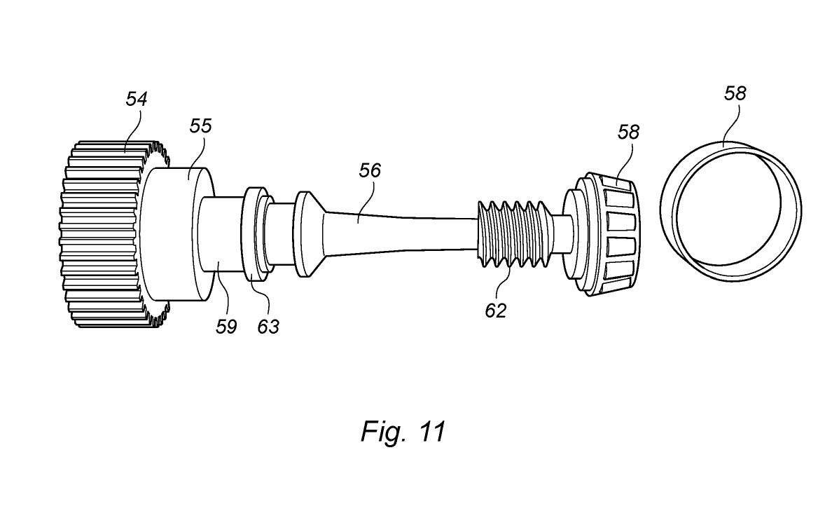

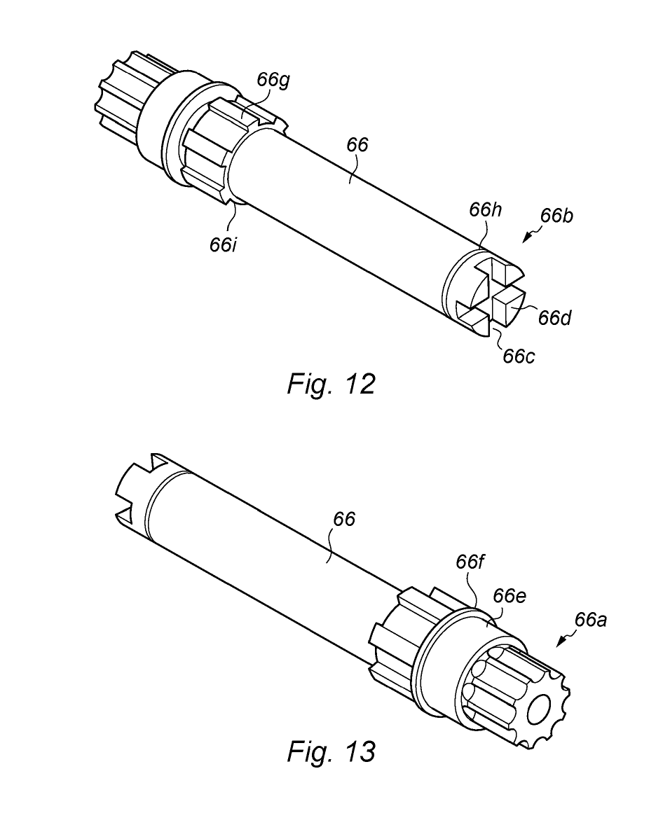

The manual mechanical propulsion unit 50 comprises a crank-set 64 mounted upon a central or mounting axle 66. The central axle 66 can be viewed in FIGS. 12 and 13.

The central axle 66 is a substantially elongate cylinder. A splined end 66a is provided on a first end, and a cross-cut keyed end 66b is located on the second end. The cross-cut keyed end 66b is formed from milling a cruciform pattern 66c at the centre of the shaft, leaving four teeth 66d. The teeth 66d are chamfered along their three innermost edges.

The central axle 66 is formed from metal, particularly an AISI 4130 steel; however, other construction materials are possible.

A second end groove 66h is provided around the axle 66 adjacent and inboard of the cross-cut keyed end 66b.

An axle boss 66e is located adjacent the splined end 66c. An axle boss flange 66f attaches to the axle boss 66e. A further splined portion 66g is located adjacent the axle boss flange 66f.

A first end groove 66i is provided around the axle 66 adjacent and inboard of the further splined portion 66g.

A splined stud 68 attaches to the cross-cut keyed end 66b. The splined stud 68 comprises a splined end 68a, largely identical to the splined end 66a of the central axle 66, a central flange 68b located adjacent the splined end 68a, and a corresponding cruciform lug pattern 68c located on the face of the central flange 68b opposite the splined end 68a.

The cruciform lug pattern 68c comprises four individual lugs 68d deployed around a central bore 68e. The outermost edges of the lugs 68d are chamfered. Splined ends 66a, 68a are standard ISIS Drive-style spline patterns, but it will be obvious to the skilled addressee that alternative spline patterns or other interference fits are possible.

Splined stud 68 is formed from metal, particularly an AISI 4130 steel; however, other construction materials are possible.

Left hand crank arm 70 attaches to the splined end 66c of central axle 66. Right hand crank arm 72 attaches to the splined end 68c of the splined stud 68.

A second axle 74 is depicted in FIGS. 18 to 21. Second axle 74 combines an elongate sleeve section 76 and a bearing mount 78. A second axle flange 79 is disposed between the elongate sleeve section 76 and the bearing mount 78.

Second axle 74 is formed from metal, particularly a 7075-T6 aluminium; however, other construction materials are possible.

A central bore 80 is located at the centre of the elongate sleeve section 76. Two key slots are formed on the sidewall of the elongate sleeve section 76: outer key slot 82 adjacent the bearing mount 78 and inner key slot 84 adjacent the distal end 86 of the elongate sleeve section 76.

A key slot aperture 88 is formed in the inner key slot 84. The key slot aperture 88 penetrates the full sidewall thickness of the elongate sleeve section 76.

The bearing mount 78 has both a socket portion 78a and an outer boss portion 78b. An inner crank-side bearing 122 locates within the socket portion 78a and an outer crank-side bearing 130 is located around the outer boss portion 78b. Both ensure smooth rotation of the components within the chassis or housing 44.

A bevel gear mount 94 is located around the second axle 74 between the flange 79 and sleeve 76. The bevel gear mount 94 comprises a frustum-shaped raised section 96 projecting from flange 79 with six tapped bevel mount bores 98 around the sidewall of the frustum-shaped raised section 96, the bores 98 having an axis parallel to the axis of the central bore 80 of the second axle 74. The six tapped bevel mount bores 98 project through the entire wall thickness of the flange 79 and bearing mount 78, such that they are accessible on both sides of the axle 74.

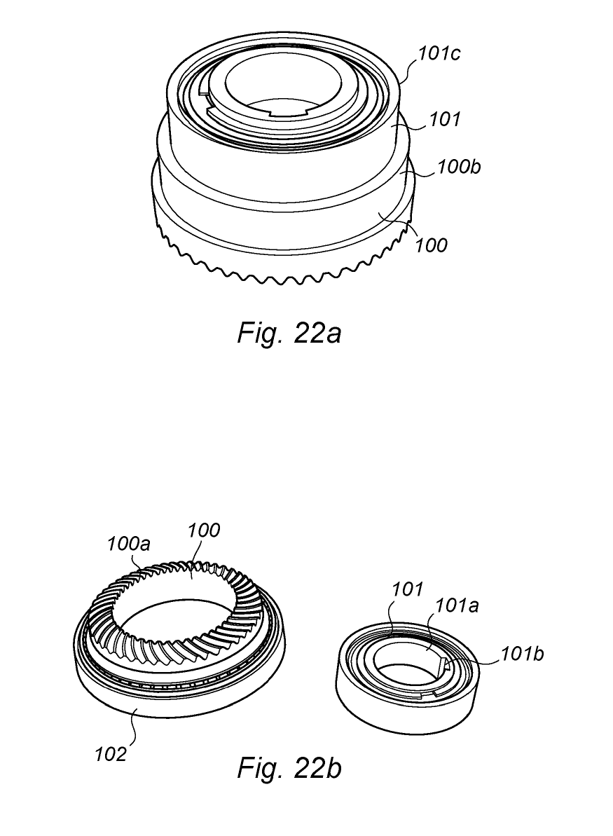

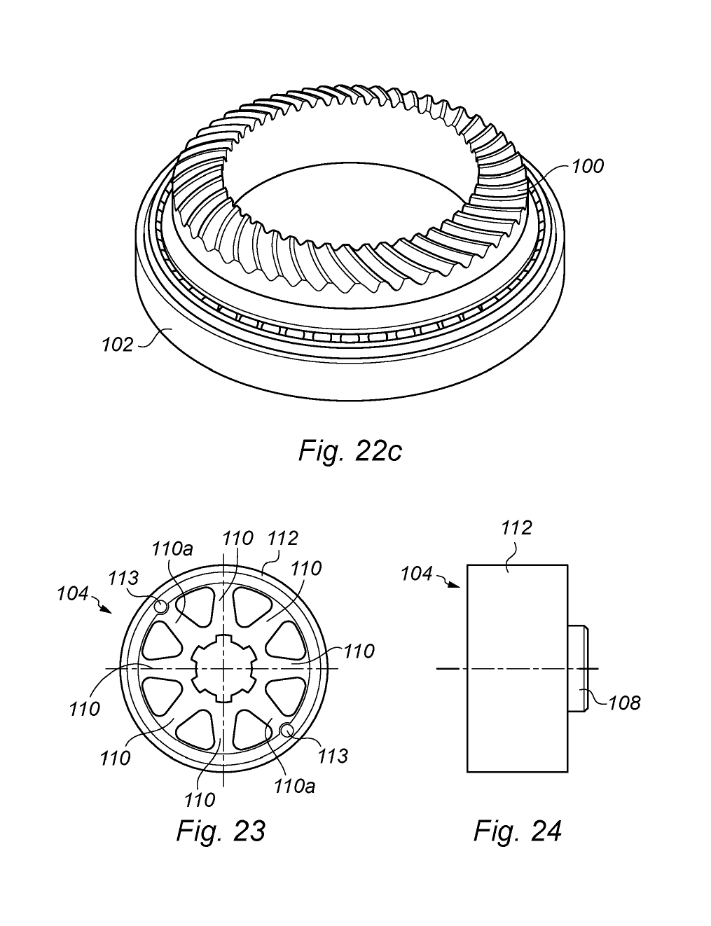

A hypoid gear assembly 99 is shown in FIGS. 22A to 22c. Hypoid gear assembly 99 comprises a phosphorous bronze hypoid gear 100 which in turn comprises a hypoid gear cone 100a formed with a hypoid gear shaft 100b. The hypoid gear shaft 100b has a relatively short axial length and functions both as a boss and mounting socket.

A hypoid gear overrunning bearing 101 is mounted within the hypoid gear shaft 100b with its outer race 101c forming an interference fit with hypoid gear shaft 100b. A hypoid gear thrust bearing 102 is mounted around hypoid gear shaft 100b, and the combined assembly 99 is mounted onto the bevel gear mount 94.

The inner race 101a of the hypoid gear overrunning bearing 101 has a keyed portion 101b. A key (not shown) rotationally couples the hypoid gear overrunning bearing 101 (and therefore phosphorous bronze hypoid gear 100) to second axle 74, via keyed portion 101b and outer key slot 82.

The hypoid gear overrunning bearing 101 is an overrunning sprag clutch bearing and hypoid gear thrust bearing 102 urges phosphorous bronze hypoid gear 100 into contact with worm gear 62.

A one way bearing wheel mount 104 comprises splined central bore 106, central hub 108, eight spokes 110 and an outer rim 112. The one way bearing wheel mount 104 is formed from metal, particularly an AISI 4130 steel; however, other construction materials are possible.

The one way bearing wheel mount 104 is mounted upon the central axle 66 around the further splined portion 66g. The splined central bore 106 of the one way bearing wheel mount 104 has a corresponding spline pattern to rotationally couple the two components.

A one way bearing 114 is mounted with its outer race 116 within one way bearing wheel mount 104, such that outer race 116 is in contact with the inner surface 112a of the outer rim 112. Mechanical fasteners (not shown) are threaded through two mount bores 113 located adjacent the outer rim 112 and two bore spokes 110a to rotationally couple bearing 114 to wheel mount 104 and therefore also to central axle 66. Notches 117 on the outer race cooperate with the mechanical fasteners.

The inner race 118 of the one way bearing 114 is attached to the second axle 74 via sleeve portion 76. A keyed portion 118a is provide on the inner race 118. A key (not shown) is used to fix the inner race 118 to the second axle 74 via keyed portion 118a and inner key slot 84.

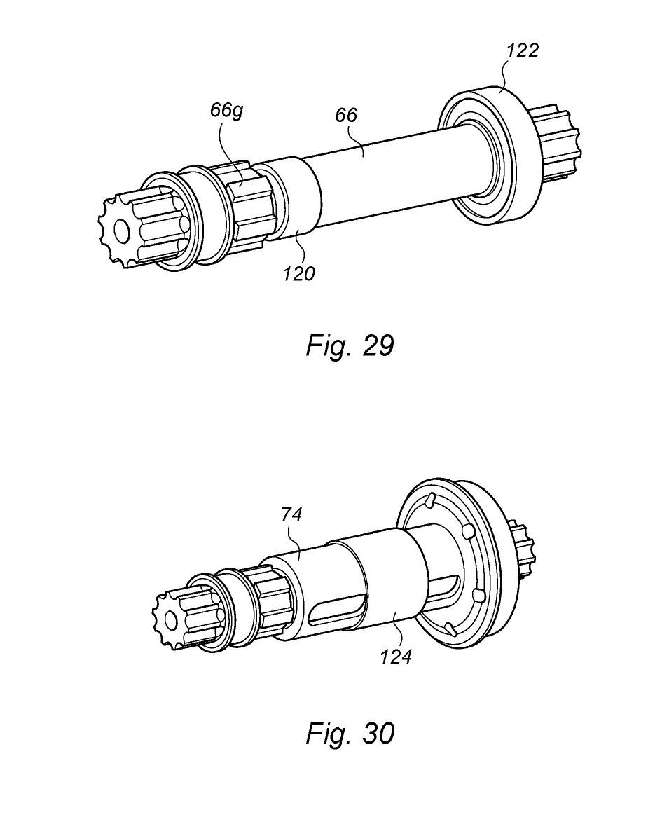

FIGS. 29 to 34 illustrate how the various central components are connected together.

A brass bush 120 is placed around central axle 66 adjacent the further splined portion 66g. A small inner crank-side bearing 122 is placed around the central axle 66 adjacent the junction where splined stud 68 attaches to the cross-cut keyed end 66b, specifically the cross-cut keyed end 66b and four teeth 66d are located and may rotate within the inner race 122a of the small inner crank-side bearing 122.

Second axle 74 is located onto central axle 66, with the near side sleeve section 76 positioned around the brass bush 120 and the bearing mount 78 and specifically socket portion 78a attaching around small inner crank-side bearing 122. Thus in the arrangement of FIG. 30 axles 66 and 74 are able to rotate freely with respect to one another.

A second axle spacer 124 is positioned around the sleeve portion 76 of the second axle 74. The hypoid gear assembly 99 abuts the second axle spacer 124 on the side proximal the bearing mount 78.

Right hand crank-arm 72 is bolted with bolt 126 to the splined stud 68 and to central axle 66. Since both the central bores of the central axle 66 and splined stud 68 are tapped, bolting mechanically fastens and rotationally couples the three components.

Large outer crank-side bearing 130 is positioned around the bearing mount 78 with its inner race 130a locating around the outer boss portion 78b. A crank side chassis aperture 44b is located around outer race 130b of the large outer crank-side bearing 130. The chassis aperture 44b is formed in the chassis or housing 44 being partially formed in the main chassis body 45 and partly in chassis cover 47.

Crank-set spider 132 comprises inner connection hub 134 and outer connection rim 136. The inner connection hub 134 has a central access aperture 138 at its centre and around its periphery six bolt holes 140.

Outer connection rim 136 comprises a skirted disk 142 around the periphery of which are four equispaced crank lugs 144. A tapped bore 146 is provided on each crank lug 144.

Crank-set spider 132 attaches to bearing mount 78. Crank 148 is attached to crank-set spider 132, with chain 150 being located around crank 148.

In the present embodiment, chain 150 drives rear sprocket 152 which in turn drives a planetary gear hub 154; however, it will be appreciated that a rear derailleur system of gearing, or indeed a simple one gear and freewheel mechanism are all possible and within the scope of the present invention.

The one way bearing wheel mount 104 and one way bearing 114 assembly abuts the second axle spacer 124 distally from the phosphorous bronze hypoid gear 100.

Slip ring arrangement 156 is located on the left-hand crank 158 side of the one way bearing wheel mount 104 and one way bearing 114 assembly; the rotating ring 156a being attached to one way bearing wheel mount 104 on the surface opposite the access point for the one way bearing 114; and the stationary ring 156b being fixed to the chassis or housing 44.

A small left-hand crank-arm bearing 160 is positioned around central axle 66 and specifically with its inner race 160a around axle boss 66e and abutting axle boss flange 66f.

A left-hand crank-arm aperture 44c is located around outer race 160b of the small left-hand crank-arm bearing 160. The left-hand crank-arm aperture 44c is formed in the chassis or housing 44 being partially formed in the main chassis body 45 and partly in chassis cover 47.

Worm gear 62 meshes with phosphorous bronze hypoid gear 100. The meshing forms an offset, hypoid-style gear arrangement. It will be appreciated by the skilled addressee that the hypoid arrangement not only allows gear axle 56 and the central axle 66 & second axle 74 to be offset from each other and therefore not interfere with one another's operation, but moreover provides such advantages well known in hypoid gear usage. It also means that gear axle 56 may be fixed at two points across the width of the phosphorous bronze hypoid gear 100 whilst still being allowed to rotate.

In use, the user applies effort by rotating left hand crank arm 70 and right hand crank arm 72 with their feet in a known fashion. This rotates central axle 66 and in turn the one way bearing wheel mount 104 and one way bearing 114 assembly via the further splined portion 66g.

This rotation is transmitted to the second axle 74 through the fixing described above. This drives the crank 148 via the crank-set spider 132, with chain 150 being located around crank 148 driving rear sprocket 152 and rear wheel 16, thereby manually propelling the bicycle 10.

The electric motor 46 may be used to assist user effort by selective control. Electric motor 46 drives gear axle 56 via the step-down gearing unit 48. The step-down gearing unit 48 as described above, transforms the low torque/high speed rotation direct from the electric motor 46 to a more usable higher torque/lower speed rotation.

Worm gear 62 drives phosphorous bronze hypoid gear 100 and through hypoid gear overrunning bearing 101 exerts additional torque onto second axle 74 and on through the crank 148 via the crank-set spider 132, with chain 150 being located around crank 148 driving rear sprocket 152 and rear wheel 16, thereby aiding the user's own manual efforts.

Since the motor 46 drives the crank 148 and not the crank arms 70, 72 and because of the arrangement of the transmission system 52, the user's pedalling effort will not be affected by the work of the motor 46. Thus, the user may cease pedalling and the motor 46 will continue to drive the crank 148 but not the crank arms 70, 72. Similarly, the user's pedalling effort cannot exert an undesirable loading onto the motor 46 or any of the transmission components which transfer rotational motion from the motor 46.

A battery 200 is located within chamber 38 in the interior of the down-tube 28. Battery 200 powers electric motor 46. Battery 200 may also be used to power auxiliary systems such as lighting and so forth.

Battery 200 is wedged into the chamber 38 by the use of foam padding (not shown) and two rods 202. These fix the battery 200 within a stationary position in the down-tube 28. The battery 200 comprises three banks 200a of nine individual cells 200b each, a total of 27 cells, in a substantially cuboidal arrangement, to fit within chamber 38.

Upper and lower brackets 202, 204 contain nine cylindrical cells 200b in a 3×3 matrix. Lower bracket 204 of uppermost cell bank 200a connects to upper bracket 202 of middle cell bank 200a, and likewise lower bracket 204 of middle cell bank 200a connects to upper bracket 202 of middle cell bank 200a. Each bracket has two rod apertures 206 for receiving mounting rods 208. Mounting rods 208 attach to housing 44.

Table 1 below provides some technical specifications for the battery 200 of the present embodiment, but the skilled addressee will appreciate that modifications are envisaged within the scope of the present invention.

TABLE 1
Technical Date:

| | |
|---|---|
| Over charge protection: | 38.25 V (4.25 V/cell) |
| Over discharge protection: | 24.3 V (2.70 V/cell) |
| Over current protection: | 16 A const. And up to 32 A for |
| | 1150 ms (higher on request) |
| Short circuit protection: | >32 A for longer than 1.12 ms |
| | (higher on request) |
| Cell balance detection voltage: | 4.125 V/cell |
| Cell balance release voltage: | 4.125 V/cell |
| Cell balance current: | 20 mA-40 mA |
| Over temperature protection: | +70° C. (for charge and discharge) |

Electric motor 46 may be simply manually controlled by a handlebar 20 located control (not shown).

Alternatively, control of the electric motor 46 may be by an automated control system.

Load cells comprising one or more strain gauges may be positioned on upper and lower surfaces 110b, 110c of one or more of the spokes 110 of bearing mount i.e. the surfaces which would be subjected to tension and compression as the rotational motion of the central axle 66 is transferred through hub 106 to outer rim 112.

The measured stresses at these points would allow for a measurement of the applied torque (and therefore a calculation of this would result in a determination of the crank rotation speed or cadence) being exerted by the user, creating a first applied torque control signal S_{T}. This signal would be fed through the slip ring arrangement 156 to a motor controller (not shown). Use of two sensors on the upper and lower surfaces of the spokes 110 improves accuracy.

Further, a similar load cell may be placed on seat post 31, the compression of which will provide an indication of the user's mass. User mass has a negligible effect on mechanical losses whilst bicycle 10 is travelling on a flat surface, but has a significant effect when bicycle 10 is going uphill. This would create user mass control signal S_{M} fed to motor controller (not shown).

Further sensors may be located at rear wheel 16. Two such sensors may be used, the first being a rear wheel sensor providing a Boolean signal S_{B} of whether the rear wheel 16 is rotating or not and providing an overall ON/OFF switch for the motor, as if the rear wheel 16 is not rotating, such as when the bicycle 10 is stopped at traffic signals, the electric motor 46 should not be providing any input.

A second rear wheel speed sensor (which may be combined with the first sensor in a single unit) provides a rear wheel speed signal S_{V}. This measured quantity is important since laws are in place around the world to limit the speed at which the electrical drive may propel such a bicycle 10, primarily for the safety of the user.

The motor controller may then use the four input signals, in combination with other data (either stored constants or measured variables) and appropriate algorithm(s), to create a control signal C_{S} for control of the electric motor 46, ensuring both optimized power usage and that the electric motor 46 only operates within certain criteria e.g. no assistance at 0 mph or beyond a pre-determined maximum speed.

Further sensor inputs may be used to further enhance battery 200 life; for example gyroscopic sensors, accelerometers, and so forth may be used to provide the motor controller with more date to enable it to provide a more efficient amount of additional power from motor 46 depending on the instantaneous conditions of the bicycle 10.

Various modifications and improvements may be made to the embodiment described above without departing from the scope of the present invention.

The transmission system need not be used within a bicycle application; it may be used within other types of vehicle and non-vehicle application. For example, it may be used in such rotational applications as wind turbines for example.

The rotational inputs need not be limited to a manual and an electrically derived input; for example, one input may be from an internal combustion engine and one from an electrical system in a hybrid vehicle for example.

1.-57. (canceled)

58. A control system for a vehicle comprising at least three sensory inputs combining to provide a control signal output.

59. A control system for a vehicle according to claim 58 wherein there are four sensory inputs.

60. A control system for a vehicle according to claim 58 wherein one of the sensory inputs is a torque sensor measuring a first rotational input torque.

61. A control system for a vehicle according to claim 58 wherein one of the sensory inputs is a weight sensor measuring the load on the vehicle including the passenger(s) weight.

62. A control system for a vehicle according to claim 58 wherein one of the sensory inputs is a Boolean wheel rotation sensor measuring whether a wheel of said vehicle is rotating.

63. A control system for a vehicle according to claim 58 wherein one of the sensory inputs is a wheel velocity sensor measuring the rotational speed of a wheel.

64. An electric bicycle including at least one control system according to claim 58.

65. A vehicle including at least one control system according to claim 58.

66. A transmission system comprising a first rotational input, a second rotational input and a rotational output, wherein the first rotational input and second rotational input may transmit a rotation to the rotational output, wherein one of the first rotational input and second rotational input is connected to the rotational output through a one way clutch, and wherein the other of the first rotational input and second rotational input is connected to the rotational output through an overrunning clutch, wherein said one way clutch and said overrunning clutch are rotationally coupled, the one way clutch is rotationally coupled to the overrunning clutch by a bracket, the bracket comprises a cylindrical housing and a cylindrical mounting and wherein the bracket comprises a mounting axle with a cylindrical housing rotationally coupled and locked to the mounting axle and the cylindrical housing extends around at least a portion of the mounting axle.

67. A transmission system according to claim 66, wherein one of the one way clutch and overrunning clutch is mounted within the cylindrical housing and the other of the one way clutch and overrunning clutch is mounted around the cylindrical mounting.

68. A transmission system according to claim 66 wherein the inner race of said one-way clutch is rotationally coupled to an outer surface of the second axle and the overrunning clutch is mounted around the outer surface of the second axle.

69. A transmission system according to claim 66 wherein the overrunning clutch is rotationally coupled to a bevel gear.

70. A transmission system according to claim 66 wherein the overrunning clutch is rotationally coupled to a hypoid gear.

71. A transmission system according to claim 66 wherein the transmission system is mounted within a housing.

72. A transmission system according to claim 71 wherein the housing is adapted to be connectible into the usual position of the bottom bracket shell of a bicycle frame adjacent a junction between the down tube, seat tube and chain stay on the bicycle frame.

73. A transmission system according to claim 71 wherein the housing further contains one or more electric motors.

74. A transmission system according to claim 71 wherein the housing further contains one or more components of a crank-set.

75. A transmission system according to claim 71 wherein the housing includes a main housing within which is located a majority or all of the components of the transmission system and a cover enabling access to the transmission system.

76. A bicycle including a transmission system according to claim 66.
